(19) United States
(12) Patent Application Publication
(10) Pub. No.: US 2025/0371993 A1
(43) Pub. Date: Dec. 4, 2025

(54) WELDING TRAINING ASSEMBLY FOR PERFORMING A VIRTUAL MANUAL WELDING PROCESS

(71) Applicant: Fronius International GmbH, Pettenbach (AT)

(72) Inventors: Almedin BECIROVIC, Wels-Thalheim (AT); Nikolaus ZAUNER, Pettenbach (AT); Christian POINTNER, Wels-Thalheim (AT); Philipp SCHLOR, Wels-Thalheim (AT); Gernot KORAK, Wels-Thalheim (AT); Victor KLAMERT, Wels-Thalheim (AT); Matthias NAGL, Wels-Thalheim (AT); Christoph MEHOFER, Wels-Thalheim (AT)

(73) Assignee: Fronius International GmbH, Pettenbach (AT)

(21) Appl. No.: 18/874,770

(22) PCT Filed: Jun. 13, 2023
(86) PCT No.: PCT/EP2023/065706

§ 371 Date: Dec. 13, 2024

(30) Foreign Application Priority Data
Jun. 14, 2022 (DE) 10 2022 206 024.5

(51) Int. Cl. G09B 9/00

(52) U.S. Cl. CPC G09B 9/00

(57) ABSTRACT

A welding training assembly including a mixed-reality headset having an RGB camera and an IR camera, in which The IR field of vision is greater than the RGB field of vision. IR-reflecting reference markers, which are arranged on a training workpiece and on a training manual welding torch in a reference pattern that individualizes the training workpiece and the training manual welding torch, are sensed by the IR camera for object recognition and object tracking.

The present invention relates to a welding training assembly and to a method for performing a virtual manual welding process.

Welding, whether oxyfuel gas welding, autogenous welding, manual arc welding, inert gas welding, plasma welding or laser welding, as the most important joining process in modern production technology, plays an essential role in a number of modern production and manufacturing processes. By way of example, reference is made to the production of modern modes of transport, such as motor vehicles, trains or aircraft, which is unthinkable without modern high-precision welding technology. As is generally the case in modern production technology, welding technology is also increasingly making use of at least partially automated welding processes (“robot welding”), which in many cases can save time and resources.

Despite the increasing use of automated welding processes, the classic form of welding, the so-called “manual welding”, is still an important element in a wide variety of technical processes. In manual welding, a manual welder carries out the required welding work by manually moving a manual welding torch. As is well-known, manual welding is divided into different manual welding processes depending on the type of materials used, such as shielded metal arc welding (electrode welding), TIG welding (tungsten inert gas welding), MIG welding (metal inert gas welding) or MAG welding (metal active gas welding).

There are many motives and reasons for using manual welding instead of automated robot welding. Welding tasks are often highly complex, individual and unique, so that automating a corresponding welding process is not possible with reasonable effort. Also for outdoor welding tasks, automation is often not possible. In other cases, the automation of a welding process may not be economically viable, inter alia due to the high initial outlay that programming a welding control system may entail.

Since the activities of a manual welder, as stated above, increasingly focus on complex and individual welding tasks, and since the constant demands for faster, more precise and cheaper welding processes also affect the manual welder performing the work, it is easy to see that training to become a manual welder is a demanding and complex process requiring a lot of practice time, extensive supervision by experienced specialists, and in particular consumables and training materials.

In order to support and simplify the process of training to become a manual welder, moreover to make the training as safe as possible for beginners, and also to save on consumables and training materials, so-called welding training assemblies for virtual welding have been developed. Welding training assemblies and the so-called “virtual welding” that can be carried out therewith make it possible to realistically simulate complex welding tasks and difficult situations and to practice them again and again in a safe and cost-effective manner. The safety risk for beginners, which in the case of welding can be high, especially due to hot and bright arcs, disappears completely in the welding training assemblies or the “welding simulator”. Using a welding training assembly for virtual welding, trainee manual welders can learn and practice basic welding skills/manual skills on common training workpieces. In addition, virtual welding can save on expensive consumables such as practice components made of different metals/steels/alloys (and their sometimes complex preparation), wire and/or inert gas and energy.

The basic components of a welding training assembly are a training manual welding torch, a training workpiece, a welding simulator and an electronic display (electronic screen). During the virtual welding process, the training manual welding torch is moved along the training workpiece. From the movement data of the training manual welding torch and from pre-set welding parameters such as welding current, wire feeding speed, etc., the welding simulator determines a so-called virtual welding seam, which is shown on the display. The specific design, in particular with regards to the recording of the movement data of the training manual welding torch or the display of the virtual weld seam on the display, can be done in different ways. The prior art offers a variety of approaches to this.

For example, US 2020/0265750 A1 describes a welding training system in which markers are applied to the training workpiece and to the training manual welding torch. For the purpose of object recognition and object tracking, i.e. recording the movement data, the markers are recorded using RGB cameras, i.e. optical cameras.

EP 2863376 A1 describes approaches for simulating different welding processes (MIG, MAG), wherein the results of these simulations are presented on the display of video glasses as part of an augmented reality (“AR”) approach. For this purpose, the outside world is captured by one or more cameras and a so-called mixed reality (real and virtual images are superimposed on one another) is displayed to the manual welder.

WO 2020/167812 A1 describes a welding helmet that can be used in virtual manual welding processes. The welding helmet comprises an electronic screen, i.e. an electronic display, and a plurality of cameras (RGB (optical). thermal imaging, infrared). WO 2020/167812 A1 also teaches markings that are applied to the training workpiece and to the training manual welding torch. The markings are captured by an optical camera for the purpose of object recognition and object tracking.

US 2021/0158724 A1 describes camera sensors, each with a plurality of adjustable lenses, filters and other optical components for performing a welding training simulation. An analysis of the sensor data captured by the camera sensors, which can, among other things, describe markers for identifying objects, is disclosed in order to determine the position, orientation and movement of the training workpieces and of the training manual welding torches from these sensor data.

Welding training assemblies known from the prior art, in particular such as the welding training assemblies disclosed in the cited documents, preferably use RGB cameras (optical cameras) for object recognition and object tracking, and usually the same RGB camera that is also used to capture the field of vision (sometimes also referred to as the field of view) of the manual welder. This situation results in a number of disadvantages. On the one hand, only components that are in the field of vision of the manual welder (i.e. in the field of vision of the RGB camera) can be tracked, i.e. identified and followed. The tracking range is therefore limited by the visual field of the manual welder. This can cause problems if the manual welder wants to examine a training workpiece from different perspectives.

In welding training assemblies according to the prior art, a manual welder must also maintain a minimum distance from the given training workpieces during virtual welding. Maintaining a minimum distance is necessary when tracking with RGB cameras in order to always be able to capture a sufficiently large region of the objects to be tracked. This requirement can sometimes significantly limit the applicability of a welding training assembly.

Also, the field of vision of an RGB camera, which simultaneously tracks objects and captures the field of vision of a manual welder, cannot be extended as desired. Approaches to this effect, for example using wide-angle lenses such as fisheye lenses, have shown that the use of such lenses can cause the manual welder to feel dizzy and unwell. Tracking based on RGB cameras is also often dependent on the given lighting conditions, which can sometimes lead to significant faults when the lighting conditions change.

It is therefore an object of the present invention to provide a welding training assembly having improved object recognition and object tracking.

This object is achieved by means of the features of the independent claims. The independent claims describe a welding training assembly and a method for performing a virtual welding process on the welding training assembly according to the invention.

The welding training assembly according to the invention comprises a training workpiece and a movable training manual welding torch. According to the invention, a first plurality of IR-reflecting reference markers are provided on the training workpiece, which are arranged on the training workpiece in a first reference pattern individualizing the training workpiece. Furthermore, a second plurality of IR-reflecting reference markers are provided, which are arranged on the training manual welding torch in a second reference pattern individualizing the training manual welding torch.

Moreover, the welding training assembly according to the invention has a mixed-reality headset on which a mixed-reality display, an RGB camera and an IR camera are provided. It is crucial here that the IR camera has a 3D IR field of vision for capturing IR images of IR-reflective reference markers arranged in the IR field of vision, which is larger than the RGB field of vision of the RGB camera. In combination with the use of the IR-reflecting reference markers according to the invention, object recognition and object tracking can thereby be improved in comparison with welding training assemblies known from the prior art. A manual welder can get much closer to a training workpiece, can perform significantly faster movements with the training manual welding torch, and a precise and accurate object recognition and object tracking, especially of the training manual welding torch, can nevertheless be ensured, even in such scenarios.

The welding training assembly according to the invention makes it possible to ensure precise and reliable tracking, i.e. object recognition and object tracking, in particular of the training workpiece and training manual welding torch, even in dynamic phases in which, for example, the training manual welding torch is moved quickly.

By means of the IR cameras according to the invention, in some cases noticeably larger tracking ranges can be captured in comparison with the prior art. In addition, the orientation of the components to be tracked is no longer subject to virtually any restrictions within the framework of the invention, and a minimum distance from the training workpiece no longer has to be maintained.

Furthermore, the welding training assembly according to the invention has a simulation unit which is designed to use the IR images of the first and the second reference patterns captured by the IR camera to determine a geometry and/or a shape and/or a type of the training manual welding torch, such as an MIG manual welding torch or MAG manual welding torch or TIG manual welding torch or shielded metal arc welding torch, as well as the training workpiece and a progression over time of the the spatial positions of the training manual welding torch and of the training workpiece relative to the headset reference point. Building on this, the simulation unit makes it possible to determine the position of a virtual welding electrode over time and, from this, a virtual weld seam on the training workpiece, with which mixed-reality images of the virtual manual welding process are generated, which are ultimately shown on a mixed-reality display that is also arranged on the mixed-reality headset.

In real welding processes, welding electrodes are used, the type and design of which, as is known, depend on the type of welding process. For example, in arc welding, an arc burns between the workpiece and a welding electrode, for which wire or strip electrodes that melt under inert gas or melting rod electrodes or even non-melting welding electrodes (e.g. tungsten-based welding electrodes) can be provided. Within the scope of the present invention, the welding electrode required for a simulated welding process, for example a wire or strip electrode that melts under inert gas or a melting rod electrode or even a non-melting welding electrode, is taken into account in the simulation in the form of a virtual welding electrode. Preferably, the type of virtual welding electrode can also be identified with the type of training manual welding torch, wherein the progression over time of the position and also the progression over time of the spatial position of the virtual welding electrode can advantageously be determined from the spatial position of the training manual welding torch determined.

Due to the fact that, within the scope of the invention, significantly more accurate information is available about the spatial positions of the components important for the virtual manual welding process, in particular of the training manual welding torch and the training workpiece, which information is also used in the simulation unit for the simulative determination of the virtual weld seam, virtual manual welding processes can be designed to be much more realistic. Increased realism increases the training effect for the manual welder, which is another parameter with respect to which the present invention achieves an improvement compared to the known prior art. Within the framework of the invention, the RGB camera is used as a so-called “live view” of the surrounding region, while tracking is performed by the IR camera. What is crucial here is that the IR camera can be equipped with a larger field of vision, which brings with it the advantage of a much larger trackable range, while avoiding the aforementioned disadvantages for a manual welder performing the work.

An important advantage of the welding training assembly according to the invention is that, due to the use of the IR camera for tracking, moving components in particular can be equipped with smaller, passive and thus more cost-effective markers compared with the prior art and can still be identified reliably and precisely.

In addition, the moving components to be tracked sometimes require significantly less hardware compared with components known from the prior art, especially since the markers are passive and therefore do not require a power supply.

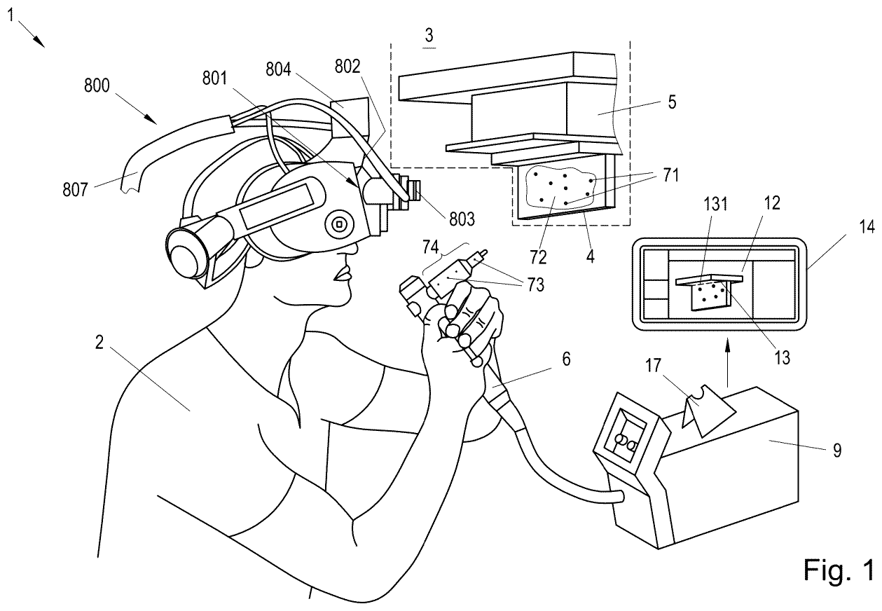

The present invention will be described in greater detail below with reference to FIGS. 1 to 12, which by way of example show schematic and non-limiting advantageous embodiments of the invention. In the figures:

FIG. 1 shows a first embodiment of a welding training assembly according to the invention,

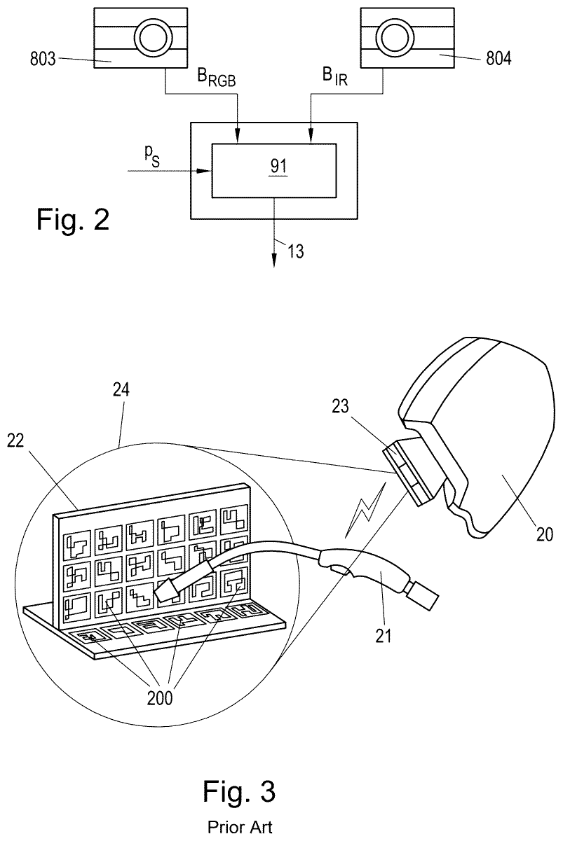

FIG. 2 shows a schematic block diagram of a simulation model in a simulation unit according to the invention,

FIG. 3 shows a welding training assembly according to the prior art,

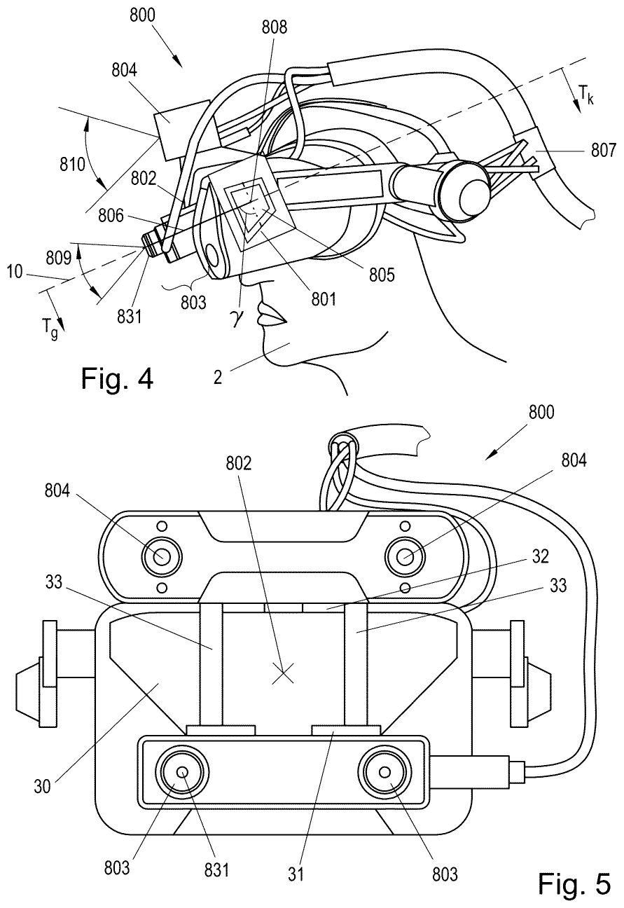

FIG. 4 shows a mixed-reality headset according to the invention,

FIG. 5 shows a front view of a mixed-reality headset and an adapter for fixing an IR camera at a given spatial distance from an RGB camera on the mixed-reality headset,

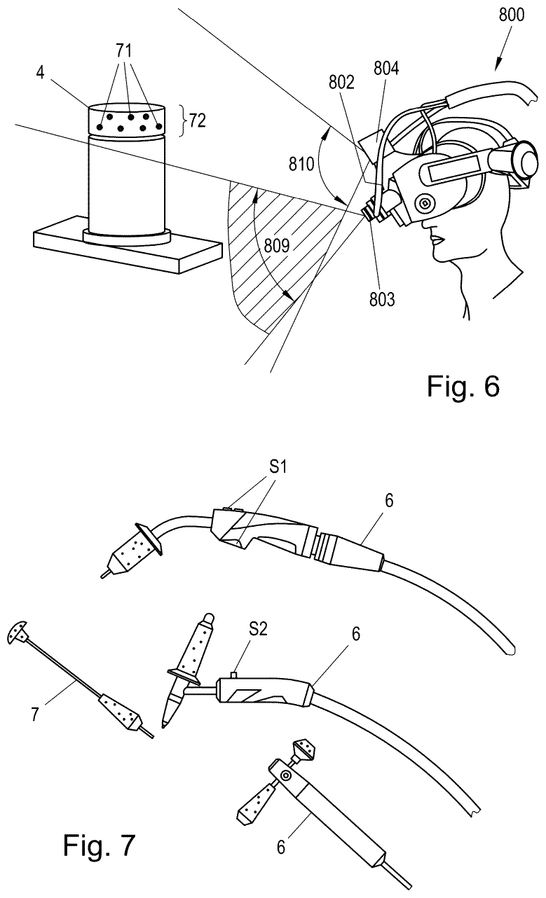

FIG. 6 shows the fields of vision of an RGB camera and of an IR camera in an assembly according to the invention on a mixed-reality headset;

FIG. 7 shows training manual welding torches designed according to the invention with IR-reflecting reference markers,

FIG. 8 shows design options of a first reference pattern for individualizing a training workpiece.

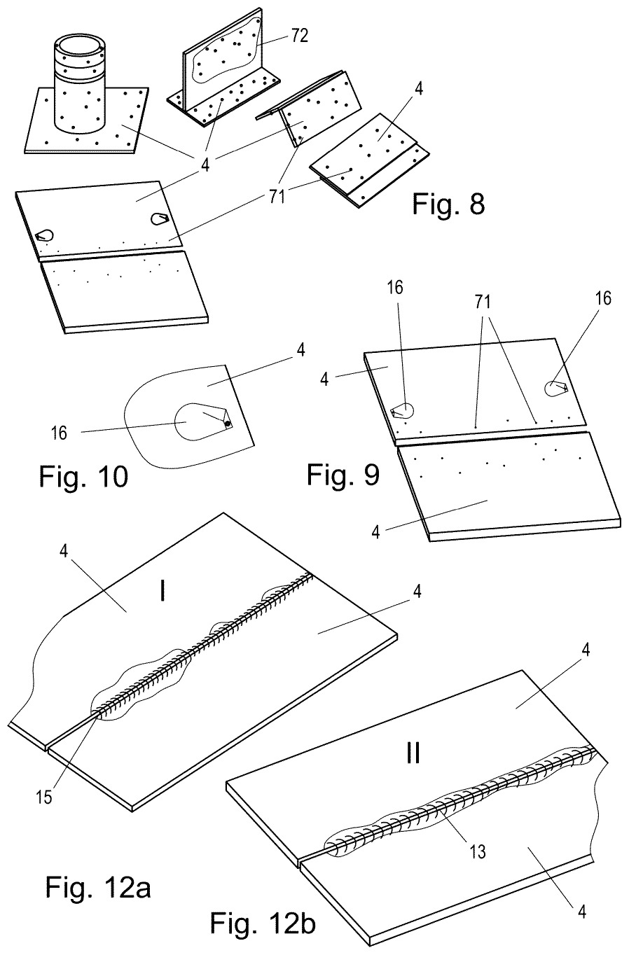

FIG. 9 shows a side view of a design of a first reference pattern for individualizing a training workpiece with a depression for arranging an IR-reflecting reference marker,

FIG. 10 shows a detailed view of a depression for the arrangement of an IR-reflecting reference marker.

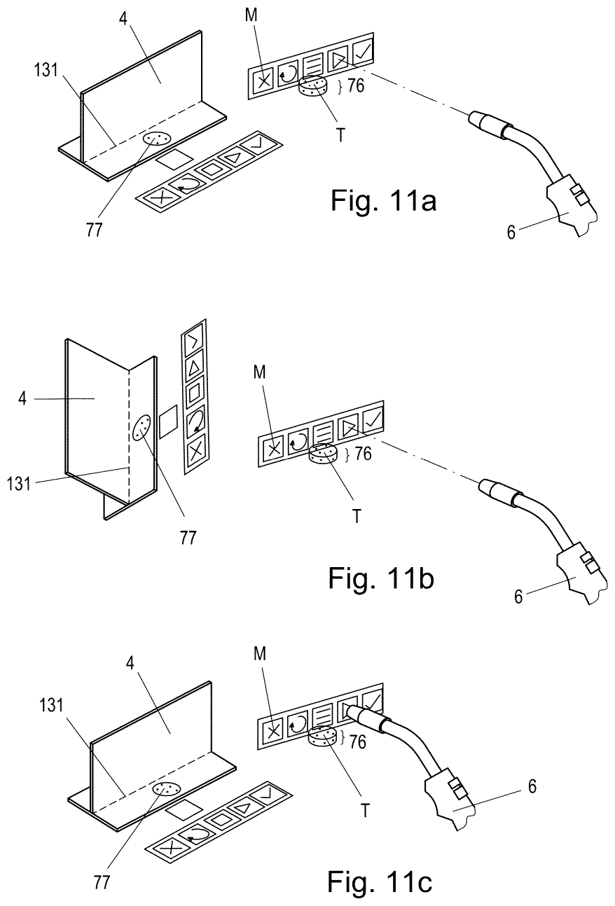

FIG. 11a, FIG. 11b, FIG. 11c show the activation of a menu or interaction menu on the mixed-reality display of a mixed-reality headset according to the invention when recording a mixed-reality target object, and

FIG. 12a, FIG. 12b show a weld seam and a weld root.

FIG. 1 shows a possible embodiment of a welding training assembly 1 according to the invention for performing a virtual manual welding process. The basic components of the welding training assembly 1 are a training workpiece 4. a manually movable training manual welding torch 6, a mixed-reality headset 800 and a simulation unit 9 comprising a torch holder 17 (shown schematically).

In the present context, mixed-reality is understood to mean mixing the natural perception of a manual welder 2 with an artificially generated (“computer-generated”) perception. Within the scope of the present invention, the natural perception of a manual welder 2 is captured by means of an RGB camera 803 and represented by RGB images generated by the RGB camera 803.

As explained in detail later on, the simulation unit 9 serves as the CPU or computing unit of the welding training assembly 1 shown. How a CPU and thus a simulation unit 9 of a welding training assembly 1 can be set up may be inferred from several prior art documents. Specifically, EP 2 863 376 A1, US 202/0265750 A1 or WO 2020/167812 A1. for example, provide explanations in this regard.

Within the scope of the present invention, a simulation unit 9 can also be integrated into a real welding device (also referred to in specialist circles as a “welding power source” or “power source”), to which a training manual welding torch 6 can be connected in a similar way to a conventional, real welding torch. In particular, the interfaces provided on a real welding device or on its housing, e.g. connections for connecting a real manual welding torch, can also be used when performing a virtual welding process, without being changed. When performing a virtual welding process by means of a simulation unit 9 integrated into a real welding device, the power supply by the real welding device, e.g. to the training manual welding torch 6, is deactivated.

A training manual welding torch 6 can in particular be a real manual welding torch which can be adapted for performing virtual manual welding processes, but can still also be suitable for performing real welding processes, such as carrying out a real TIG welding process.

In order to arrange the training workpiece 4, a workpiece holder 5 is provided in the embodiment shown in FIG. 1, on which the training workpiece 4 can be mounted. By means of a workpiece holder 5, a wide variety of so-called welding positions can in particular be simulated. As is known, welding positions describe the position and/or orientation and/or arrangement of the workpieces, of the torch and of the welding electrode and thus the position and/or orientation and/or arrangement of a weld seam during a welding process. In this regard, the standard DIN EN ISO 6947 or section IX (QW-120) of the ASME code define a number of possible welding positions, such as PA (horizontal welding of butt and fillet welds), PB (horizontal welding of fillet welds, horizontal-vertical position) or PC (transverse position or transverse seam, horizontal welding on a vertical wall). Particularly when welding vertical weld seams, complicating effects can occur, such as the downward flow of melt, which can also be taken into account within the scope of the present invention and represented as part of the virtual manual welding process.

In order to arrange the training workpiece 4 on the workpiece holder 5, various mounting methods are conceivable. The training workpiece 4 can thus be magnetically mounted on the workpiece holder 5. or screwed or clamped or glued or cast onto the workpiece holder 5, or wedged or simply placed thereon. Furthermore, the workpiece 4 can generally be mounted by a form-fitting, force-fitting and/or integral bond. In the case of magnetic mounting, the training workpiece 4 may be equipped with at least one metal component and the workpiece holder 5 with at least one magnet to provide a magnetic holding force. Implementations with magnets in the training workpiece 4 and/or metal components in the workpiece holder 5 are also conceivable. The space in which the training workpiece 4, and possibly the workpiece holder 5 and possibly the training manual welding torch 6 and the torch holder 17 are arranged in a welding training assembly 1 is often referred to as the 3D welding environment 3.

However, a workpiece holder 5 does not constitute a mandatory component of a welding training assembly 1 according to the invention. However, a torch holder 17 does not constitute a mandatory component of a welding training assembly 1 according to the invention. This means that a training workpiece 4 can also be placed freely and loosely. The function of the welding training assembly 1 according to the invention is not influenced by the type of arrangement of the training workpiece 4.

The use of just a single training workpiece 4 is also merely an example. Likewise, a further, second training workpiece 4 or a plurality of further training workpieces 4 can be provided. The training workpieces 4 can have the same shape or different shapes. The use of a plurality of training workpieces 4 can be provided in cases where welding processes are simulated on the welding training assembly 1 which aim to join a plurality of workpieces. The basic mode of operation of the welding training assembly 1 remains unchanged, which is why the following description of the invention, without restricting its generality, assumes only one training workpiece 4.

The principle for training manual welders 2 implemented using the basic components consisting of a training workpiece 4, training manual welding torch 6, mixed-reality headset 800 and simulation unit 9 provides for creating a virtual weld seam 13 on the training workpiece 4 by manually moving the training manual welding torch 6 and displaying the virtual weld seam 13 together with the training workpiece 4 to the manual welder 2. The virtual weld seam 13 does not actually exist, but is determined by simulating a real welding process in accordance with movement data from the manual welding torch 6 and the training workpiece 4. In order to visualize it, the virtual weld seam 13 is displayed as part of a sequence of mixed-reality images 12 of the virtual manual welding process on a mixed-reality display 801, which is arranged on the mixed-reality headset 800. Possible design variants of a mixed-reality display 801 are well-known from the prior art; preferably, liquid crystal displays or liquid crystal screens can be used for this purpose.

By using a welding training assembly 1 as shown in FIG. 1, various welding processes such as MIG, MAG, TIG, plasma or shielded metal arc welding processes can be learned without any safety risk.

In order to render the impressions obtained in a welding training assembly 1 as similar as possible to a real welding situation, the manual welder 2 can also wear welding gloves and/or protective equipment during virtual welding, thereby also achieving a high degree of similarity between real and virtual welding with regard to the clothing to be worn by the manual welder 2. Within the scope of the invention, it is also conceivable to integrate the mixed-reality headset 800 into a real welding helmet for this purpose.

In order to implement the basic virtual welding principle described above, an RGB camera 803 is provided in the welding training assembly 1 (FIG. 4), which optically records the components used in virtual manual welding, in particular the training manual welding torch 6 and the training workpiece 4, provided that they are in the field of vision of the RGB camera 803. The RGB camera 803 can be designed as a conventional digital camera, i.e. as an optical instrument or photographic apparatus for recording moving images. The RGB camera 803 can be equipped with suitable or necessary lenses, apertures, optical filters, etc.

A number of approaches to designing a digital camera can be found in the prior art; for example, reference is made to DE 10 2005 053 276 A1 or U.S. Pat. No. 10,877,266 B2 in this regard. It is essential for the RGB camera 803 used within the context of the present invention to be capable of capturing “visible light”, i.e. light from the visible part of the electromagnetic spectrum. As is known, visible light includes electromagnetic waves having wavelengths in the range of from 400 nm to 780 nm.

The RGB camera 803 is arranged on the mixed-reality headset 800 and allows RGB images of objects located in the field of vision of the RGB camera 803, hereinafter “RGB field of vision” 809, to be captured. The term “field of vision” refers to the region within the angle of view of an optical apparatus within which objects or events or changes can be perceived by the optical apparatus and thus recorded by the RGB camera 803. The terms “field of vision” and “angle of view” are well-known to those skilled in the field of camera technology.

In order to carry out the virtual manual welding process in question and to visualize it, it is necessary that at least part of the training workpiece 4 and at least part of the training manual welding torch 6 are in the RGB field of vision 809 of the RGB camera 803 at least at one point in time during the manual welding process. Advantageously, at least three, preferably at least four or particularly preferably at least five IR reference markers 71, 73 are arranged in the RGB field of vision 809 of the RGB camera 803. However, this condition does not exclude the possibility that the manual welder 2 briefly turns away from the training workpiece 4 when performing the virtual manual welding process and, for example, temporarily turns his gaze to the floor. Typically, however, the manual welder 2 works facing the training workpiece 4, which is why the above requirement is usually consistently met.

The simulation unit 9 of the welding training assembly 1 shown in FIG. 1 is designed to determine a geometry and/or a shape and/or a type of the training manual welding torch 6 and of the training workpiece 4 and in particular the spatial positions over time of the training manual welding torch 6 and of the training workpiece 4 when performing virtual welding. In order to implement this identification and following of the spatial positions of the training manual welding torch 6 and the training workpiece 4, also referred to as “tracking” in the prior art, a first plurality of infrared-reflecting reference markers 71, hereinafter “IR-reflecting” reference markers 71, and a second plurality of IR-reflecting reference markers 73 are provided within the scope of the welding training assembly 1 according to the invention. As explained in detail below, the IR-reflecting reference markers 71, 73 according to the invention can sometimes be made significantly smaller compared with approaches known from the prior art, with preferred diameters or maximum dimensions or maximum distances between two points of the edge of a reference marker 71, 73 being in the range of only a few millimeters.

In the present context, “infrared” is understood to mean infrared radiation, also called IR radiation, which is known to correspond to electromagnetic radiation in the spectral range between visible light and longer-wave terahertz radiation. Specifically, this means light with a wavelength between 780 nm and 1 mm, corresponding to a frequency range of 300 GHz to 400 THz or a wave number range of 10 cm¹ up to 12 800 cm¹. The IR-reflecting reference markers in question are characterized in that they preferably reflect more than 70% or very preferably more than 80% or particularly preferably more than 90% or most preferably more than 99% of the IR radiation impinging thereon.

The first plurality of IR-reflecting reference markers 71 are arranged in a first reference pattern 72 on the training workpiece 4 that individualizes the training workpiece 4. In contrast, the second plurality of IR-reflecting reference markers 73 are arranged in a second reference pattern 74 on the training manual welding torch 6 that individualizes the training manual welding torch 6.

A “reference pattern” is a specific geometric arrangement of a plurality of IR-reflecting reference markers. “Individualizing” means that a reference pattern is unique and therefore one reference pattern can be differentiated from another reference pattern. The reference pattern preferably individualizes from different viewing directions, with only part of the reference pattern being visible from different viewing directions.

In order to capture the IR-reflecting reference markers 71, 73, the present invention provides an IR camera 804 designed specifically for this purpose.

An IR camera 804 is understood in the present case to be an optical device similar to a conventional camera, which is capable of receiving and processing infrared radiation and additionally reproducing the IR radiation as an image. Light in a spectral range other than the IR range is not recorded by the IR camera 804. The IR camera 804 can also be equipped with appropriate optical filters.

According to the invention, the IR camera 804 is arranged on the mixed-reality headset 800 at a predetermined fixed spatial distance from the RGB camera 803 (FIG. 4). Similarly to the RGB camera 803, the IR camera 804 has its own field of vision, referred to below as the “IR field of vision” 810. The IR camera 804 allows IR images of IR-reflecting reference markers 71, 73 located in the IR field of vision 810 to be captured. Capturing the IR-reflecting reference markers 71, 73 involves capturing at least parts of the aforementioned reference pattern 72, 74 which individualizes the training workpiece 4 and the training manual welding torch 6.

An essential property of the IR camera 804 used according to the invention is that the IR field of vision 810 thereof is larger than the RGB field of vision 809 of the RGB camera 803, preferably larger in at least one solid angle. According to the invention, the IR field of vision 810 and the RGB field of vision 809 overlap.

During performance of the virtual manual welding process, at least part of the first reference pattern 72 and at least part of the second reference pattern 74 are located in the IR field of vision 810. This circumstance will be discussed separately later on.

In order to assign reference patterns 72, 74 to specific training workpieces 4 or training manual welding torches 6. a database or a database entry or a list can be stored in the simulation unit 9, which links different reference patterns 72, 74 to descriptions of training workpieces 4 or training manual welding torches 6. If a reference pattern 72, 74 or part of the reference pattern 72, 74, which allows a conclusion to be drawn about the entire reference pattern 72, 74, is now captured by the IR camera 804, the training workpiece 4 of interest and its properties can be identified by comparing it with the database entries provided. The database entries can contain a description of the geometry, dimensions, material, etc. of the training workpiece 4. The same applies to training manual welding torches 6, which can also be identified by comparing captured reference patterns 74 with corresponding database entries.

Preferably, and thus also within the scope of the embodiment of the invention shown in FIG. 1, IR images and RGB images are continuously recorded at discrete points in time k. “Continuously” is to be understood here as the repeated recording of IR images and RGB images at said discrete points in time. It should be noted that the RGB camera 803 and the IR camera 804 can also be clocked differently within the scope of the invention and can therefore have different scanning times.

According to the above statements, continuously captured IR images lead to continuously captured parts of the first and second reference patterns 72, 74, from which a continuous description of the spatial positions of the training workpiece 4 and of the training manual welding torch 6 can be deduced in the simulation unit 9. For this purpose, the captured RGB images and the captured IR images are supplied to the simulation unit 9. For this purpose, the RGB camera 803 and the IR camera 804 can be connected to the simulation unit 9, for example by wires, in order to transmit the recorded image data. However, within the scope of the present invention, a wireless connection of the RGB camera 803 and the IR camera 804 to the simulation unit 9 is also conceivable. Known concepts such as Bluetooth, WLAN or ZigBee can be used to wirelessly connect the RGB camera 803 and the IR camera 804 to the simulation unit 9.

From the continuous description of the spatial positions of the training workpiece 4 and of the training manual welding torch 6, the relative movement between the training manual welding torch 6 and the training workpiece 4 required for implementing the virtual welding process can ultimately be determined in a known manner. In an advantageous manner, the acceleration and speed of the training workpiece 4 and of the training manual welding torch 6 can also be determined from the progression of their positions, which can also be taken into account when determining the virtual weld seam 13.

It should be noted that the determination of the spatial positions and the resulting progressions of the position of the training manual welding torch 6 and of the training workpiece 4 are carried out relative to a headset reference point 802, which is defined as a fixed point on the mixed-reality headset 800. However, the headset reference point 802 moves with the mixed-reality headset 800, allowing great flexibility in the position description. The specific design of this position description based on the headset reference point 802 will be discussed in detail later on.

Furthermore, spatial positions and resulting progressions of the position of the training manual welding torch 6 or of the training workpiece 4 can not only be determined but also evaluated. On the basis thereof, instructions can be output on the mixed-reality display 801 or information can be output on the mixed-reality display 801, for example that the manual welder 2 has positioned the training workpiece 4 incorrectly, whereupon information or instructions for correcting the position can subsequently be given.

In order to determine a continuous description of the spatial positions of the training workpiece 4 and of the training manual welding torch 6, geometric reference points on the training workpiece 4 and on the training manual welding torch 6 can first be determined. The geometric reference points on the training workpiece 4 and on the training manual welding torch 6 can be determined, for example, from the reference patterns 72, 74 applied to the training workpiece 4 and to the training manual welding torch 6. On the basis thereof, for example, three-dimensional position vectors can be determined which describe the relative positions of the geometric reference points on the training workpiece 4 and on the training manual welding torch 6 in relation to the predetermined geometric headset reference point 802. These position vectors can be determined from the image data captured by the IR camera 804.

A temporal progression of image data from the IR camera 804 can establish a temporal progression of these position vectors, from which the progressions of the position of the training workpiece 4 and of the training manual welding torch 6 can be derived as a direct consequence. Position progressions can therefore be understood as a temporal sequence of position vectors which describe the relative positions of the training workpiece 4 and of the training manual welding torch 6 in relation to the headset reference point 802.

The orientations of the training workpiece 4 and of the training manual welding torch 6 relative to the headset reference point 802 can preferably also be determined from the reference patterns 72, 74. Furthermore, in order to also determine the orientation of the training workpiece 4 and/or of the training manual welding torch 6 in the 3D welding environment 3 or generally in three-dimensional space, further sensors can also be provided which provide further sensor data that can be used for this purpose. These sensors, which can also be used to determine the welding positions (PA, PB, . . . ) mentioned at the outset, will be discussed separately later on.

In combination with the determined position progressions, and given the known geometry of the training workpiece 4 and of the training manual welding torch 6, the corresponding spatial positions over time can be determined from the orientation of the training workpiece 4 and of the training manual welding torch 6.

Within the scope of the welding training assembly 1 shown in FIG. 1, it is further provided, proceeding from the progressions of the position of the training manual welding torch 6 and of the training workpiece 4, to determine a virtual weld seam 13 which the manual welder has created on the training workpiece 4 during the virtual manual welding process, while taking into account at least one predetermined training welding parameter ps. The virtual weld seam 13 is preferably determined by simulating a real manual welding process, under the boundary condition that a real manual welding torch, which is preferably equipped with a corresponding welding electrode, is moved over time relative to the training workpiece 4 in accordance with the determined position of the training manual welding torch 6, wherein a corresponding welding electrode is represented in the simulation by a virtual welding electrode. Especially in MIG/MAG welding, a variable length of the virtual welding electrode can also be taken into account. For this purpose, a suitable welding simulation model 91 can be implemented on the simulation unit 9, which determines a virtual weld seam 13 from the progressions over time of the position of the training manual welding torch 6 and of the training workpiece 4 and consequently from the position of a virtual welding electrode, taking into account at least one predetermined training welding parameter ps. The prior art offers a number of approaches for simulating a real manual welding process, for example in RU 2694147 C1, WO 2020/056388 A1 or US 2015/0352794 A1.

The simulation unit 9 is implemented as a computer or as computer-based hardware. A simulation model 91 can be implemented as software that runs on the simulation unit 9. The set-up of a simulation model 91 is shown schematically in FIG. 2 using a block diagram. The simulation model 91 is arranged in the simulation unit 9 and receives image data B_{RGB} from the RGB camera 803, image data B_{IR} from the IR camera 804 and training welding parameters p_{S}. From these, the simulation model 91 determines the virtual weld seam 13. According to the invention, the virtual weld seam 13 is subsequently displayed on the mixed-reality display 801 of the mixed-reality headset 800.

The simulation model 91 can advantageously be designed to also take into account the introduction of additional materials as is customary in welding technology. For this purpose, depending on the type of welding selected, further sub-simulation models can be used which use a model to describe the introduction of additional materials.

The at least one predetermined training welding parameter p_{S} can correspond to a welding current or a welding voltage or a welding speed or a workpiece geometry or an idle time or a preheating temperature or a wire feeding speed or an arc length or a welding type or an inert gas setting, in particular a flow rate of an inert gas. A different selection of the training welding parameter p_{S} is, however, also conceivable within the scope of the present invention. Typically, not only a single training welding parameter p_{S} is predetermined, but also a variety of training welding parameters p_{S}, since welding is a complex physical process that usually requires a plurality of parameters to be established.

The training welding parameters p_{S} mentioned can advantageously also be changed during a virtual manual welding process, for which purpose a suitable, preferably haptic, operating element can be provided on the simulation unit 9, for example a rotary potentiometer. For example, a haptic operating element can be used, preferably exclusively, to regulate a simulated inert gas as a training welding parameter p_{S}, and other training welding parameters p_{S} can be set elsewhere, for example, such as on a tablet as a portable display element 14, which will be discussed separately later on.

The determined virtual weld seam 13 and the associated welding progress must be graphically prepared and displayed in a final step. For this purpose, a mixed-reality display 801 is provided on the mixed-reality headset 800. In the graphic display of the above, attention must be paid to the current point in time T_{cur} during the virtual manual welding process. According to the invention, at least the part of the virtual weld seam 13 determined up to a current point in time T_{cur} of the virtual manual welding process, which virtual weld seam is within the RGB field of vision 809 provided at the current point in time T_{cur}, is superimposed on the RGB image provided at the current point in time T_{cur} in order to generate a mixed-reality image 12 of the virtual manual welding process at the current point in time _{cur}. The virtual weld seam 13 is of course superimposed in the correct spatial orientation and position relative to the training workpiece 4 in order to correctly display the virtual weld seam 13 on the training workpiece 4.

A mixed-reality image 12 determined in accordance with the above statements is subsequently transmitted to the mixed-reality display 801 provided on the mixed-reality headset 800 in order to display it as part of the sequence of mixed-reality images 12 of the virtual manual welding process on the mixed-reality display 801.

As shown in FIG. 1, the mixed-reality image 12 can also be displayed on an additional display element 14. This allows, for example, an instructor to observe the virtual welding process. The display element 14 can also show the trainer a mixed-reality image 12 of the virtual welding process from the trainer's perspective. Furthermore, it is also possible for the trainer to give the manual welder 2 visual instructions or tips, which can be transferred from the display element 14 to the mixed-reality display 801 in real time.

The described steps of determining the progressions of the position of the training manual welding torch 6 and of the training workpiece 4, of determining the virtual weld seam 13 and of creating the mixed-reality image 12 are preferably carried out in the simulation unit 9, i.e. the CPU or computing unit of the welding training assembly 1 in question. Possible implementations of a simulation unit 9 are provided, among other things, by microprocessor-based hardware, such as microcontrollers and integrated circuits (ASIC, FPGA). However, other approaches to the design of simulation unit 9 are also conceivable. A plurality of simulation units 9 can thus also be provided, or the simulation unit 9 can be connected to a plurality of other simulation units 9 via a computing cloud.

The simulation unit 9 can be designed to carry out further complex calculations in addition to the calculation of the virtual weld seam 13. For example, starting from the determined virtual weld seam 13, a virtual metallurgical structure and/or a virtual stress-induced distortion and/or a virtual grain structure of the metallurgical structure, which can occur as a consequence of the virtual weld seam 13 in the training workpiece 4, can be determined in subsequent mechanical simulations in the simulation unit 9, and, if required, also displayed.

The simulation unit 9 can also be designed to determine so-called welding quality parameters on the basis of subsequent mechanical simulations, which describe a quality and/or a grade of the virtual weld seam 13. Welding quality parameters can describe a seam thickness, fatigue behavior, a weld seam transition or an edge offset, as described, for example, in the standard DIN EN ISO 581. Advantageously, it can be provided to display determined welding quality parameters on the mixed-reality display 801 in addition to the virtual manual welding process.

The simulation unit 9 can also be designed to superimpose a predetermined virtual ideal weld seam 131 (shown by dashed lines in FIG. 1 and FIG. 11a-c) to be generated by the virtual manual welding process on the provided RGB images. Following on from this, the mixed-reality display 801 can of course be designed to display the RGB images superimposed with the virtual ideal weld seam 131. With regard to a virtual ideal weld seam 131, the simulation unit 9 can also be designed to determine one or more seam quality parameters, which can, for example, describe a difference between the determined virtual weld seam 13 and the predetermined ideal weld seam 131. In this way, an objective and comprehensible assessment of the virtual weld seam 13 created by a manual welder is possible.

In order to evaluate the generated virtual weld seam 13, a difference threshold can advantageously be predetermined. If there is a difference between the determined virtual weld seam 13 and the predetermined ideal weld seam 131 that exceeds a predetermined difference threshold, the simulation unit 9 or another element of the welding training assembly 1 can be designed to alert the manual welder 2 to this difference and thus to associated welding errors by means of acoustic and/or visual signals. Preferably, these acoustic and/or visual signals are output via the mixed-reality headset 800, for which purpose the mixed-reality headset 800 can be equipped with suitable loudspeakers.

Moreover, the simulation unit 9 can be designed to enable data to be backed up and/or welds to be recorded, thereby enabling a trainee manual welder 2 to view a virtual manual welding process once again, analyze errors and document learning progress.

In a particularly preferred manner, the simulation unit 9 can also be arranged on the mixed-reality headset 800. The simulation unit 9 can thus be a component of the mixed-reality headset 800 or an integral, i.e. non-detachably connected, component of the mixed-reality headset 800. For example, a free-standing simulation unit 9 can be dispensed with.

In contrast to a real manual welding process, a virtual manual welding process usually does not require any preparation or post-processing of the training workpiece. Especially when welding steel, the welding result is often crucially dependent on the preparation of the seam. One of the most important prerequisites for good welds is the cleanliness of the weld seam edges. These must not only be metallically bright, i.e. free from oxides and/or scale, but must also not contain any contamination from fats, oils or other organic substances that can lead to carburization and inclusions in the weld seams. Preparation and post-processing are not required for training workpieces 4. In an advantageous embodiment, however, the present invention allows inadequate preparation of a manual welding process to be deliberately prespecified in a simulation unit 9 according to the invention and to be taken into account in a simulation for calculating the virtual weld seam 13, in particular in order to show a trainee manual welder 2 the effects associated with inadequate preparation of a manual welding process.

The embodiment of the welding training assembly 1 shown in FIG. 1 also has an optional, further display element 14. However, the further display element 14 is not a mandatory component of the welding training assembly 1 according to the invention, but merely serves to display the virtual manual welding process for other people besides the manual welder 2, such as an instructor or other training personnel. For this purpose, the further display element 14 can preferably be designed to be detachable from the simulation unit 9, for example in the form of a tablet which can be removed from the simulation unit 9 and can be reattached thereto, for example by means of a plug-in connection. However, a further display element 14 is of course not a necessary prerequisite for the welding training assembly 1 according to the invention.

In a display element 14, preferably in a display element 14 implemented as a tablet, it may be possible to set different front ends, i.e. different graphical user interfaces. A front end of the display element 14 can be adapted to a real welding device simulated in the simulation or to corresponding operating units of a real welding device simulated in the simulation such that the operating units of various real welding devices can be realistically simulated. A 3D view can also provide the mixed-reality display 801 of the mixed-reality headset 800 with the option of changing the front end, among other things in order to likewise adapt It to a real welding device simulated in the simulation. A front end can preferably be synchronized and coordinated with training welding parameters p_{S}, which are taken into account in a virtual manual welding process, since not every front end necessarily has the same training welding parameters p_{S}.

In addition to the mere representation of the virtual manual welding process for two other persons in addition to the manual welder 2, it can be provided to control a virtual manual welding process via a display element 14, preferably via a portable tablet. In particular, it can also be provided to control a virtual manual welding process exclusively via a portable tablet. If a removable display element 14 is provided, there will preferably be no further display elements on the remaining part of the simulation unit 9, apart from a few status LEDs for signaling and/or displaying a state of the simulation unit 9.

In comparison to the previously discussed welding training assembly 1 according to the invention, FIG. 3 shows a welding training assembly according to the prior art. It is obvious that to identify the welding torch 21 and the workpiece 22, markers covering a large surface area (e.g. so-called “image markers”, such as the ArUco markers well-known in the field of image processing, whose diameter is typically larger than 1 cm) are used throughout, which are captured by an RGB camera 23.

The embodiment shown in FIG. 3 has the obvious disadvantage that only components that are located in the RGB field of vision of the RGB camera 23 can be tracked, i.e. identified and followed. The so-called tracking range, indicated in FIG. 3 by the circle 24, is thus limited by the visual field of the manual welder 2 and the field of vision of the RGB camera.

Also, the field of vision of an RGB camera, which simultaneously tracks objects and captures the field of vision of a manual welder 2, cannot be extended as desired. Tests to this effect, for example using wide-angle lenses such as fisheye lenses, have shown that the use of such lenses can cause the manual welder 2 to feel dizzy and unwell. Tracking based on RGB cameras is also often dependent on the given lighting conditions, which can sometimes lead to significant faults when the lighting conditions change.

The above-mentioned problems of the prior art are solved by means of the welding training assembly 1 according to the invention, wherein the mixed-reality headset 800 is particularly important for solving these problems. A possible embodiment of a mixed-reality headset 800 according to the invention is shown in FIG. 4. The mixed-reality headset 800 illustrated has a mixed-reality display 801 for displaying the sequence of mixed-reality images 12 in the virtual manual welding process.

Needless to say, the mixed-reality display 801 is naturally arranged on the mixed-reality headset 800 such that a person wearing the mixed-reality headset 800 has the mixed-reality display 801 in his field of view.

The mixed-reality headset 800 shown is assigned a predefined geometric headset reference point 802. This does not result in a static coordinate system that does not change during the virtual manual welding process and is used to describe the spatial positions of the training workpiece 4 and of the training manual welding torch 6. It is rather the case that the aforementioned headset reference point 802 can be used as the origin of a movable coordinate system, which moves with the movement of the manual welder 2 and thus with the movement of the mixed-reality headset 800. In contrast, in approaches known from the prior art, in which, for example, RGB cameras are immovably arranged on tripods in the room accommodating the welding training assembly, only the use of static coordinate systems is possible. By means of reference point 802 on the mixed-reality headset 800, tracking, i.e. the identification and tracking of objects such as the training manual welding torch, can sometimes be made significantly more dynamic and better adapted to a given welding situation in a specific individual case.

A mixed-reality headset 800 may further comprise a counterweight element 807, as described with reference to the embodiment in FIG. 4. The counterweight element 807 counteracts a torque T_{g} that develops due to the weight or weight distribution of the RGB camera 803 and/or the weight of the IR camera 804 and/or the weight of the mixed-reality display 801 and acts normally with respect to the line of sight 10 of the mixed-reality headset 800, with a torque T_{g}.

In the present context, it has been found that a mixed-reality headset 800, in particular when connected to the simulation unit 9 by means of cables, as shown in FIG. 4, can have an overall weight of the mixed-reality headset 800 that is sometimes considerable.

A heavy weight distributed asymmetrically across the head of a manual welder 2 can, for obvious reasons, lead to strain on the back and neck of the manual welder 2. Although the counterweight element 807 does not reduce the overall weight of the mixed-reality headset 800, it does distribute it more symmetrically over the head of a manual welder 2. In this way, the duration of training units can sometimes be considerably extended, which can increase the intensity of welding training and enables better training effects and progress to be achieved.

The line of sight 10 is to be understood here as a line along which the manual welder 2 would be looking at the training workpiece 4 if the manual welder 2 were not wearing the mixed-reality headset 800. In a preferred embodiment of the mixed-reality headset 800, the line of sight 10 can correspond to an optical axis of the RGB camera 803.

As shown in FIG. 4, the RGB camera 803 has at least one RGB lens 831, the optical axis 806 of which intersects the display surface 805 facing the manual welder 2 at a display intersection 808 at a display intersection angleγ. An optical axis 806 and the line of sight 10 may coincide, particularly in cases where the display intersection angle γ is 90 degrees. In principle, it is advantageous to arrange the RGB camera 803 and the mixed-reality display 801 in such a way that the display intersection angle γ is between 70 degrees and 110 degrees or between 80 degrees and 100 degrees or between 85 degrees and 95 degrees.

If the line of sight 10 and the optical axis 806 do not correspond, the mixed-reality headset 800 is preferably designed such that the line of sight 10 and the optical axis 806 have a common intersection point and diverge at an angle of less than 10 degrees, or at an angle of less than 5 degrees, or at an angle of less than 1 degree.

In an advantageous manner, the counterweight element 807 can additionally ensure a predetermined cable routing of the cables used to connect the simulation unit 9 and the mixed-reality headset 800. In particular, this can ensure that the cables do not touch the manual welder 2 and thus do not interfere with the virtual manual welding process.

In a preferred manner, the shape of the counterweight element 807 is changeable and/or its position on the mixed-reality headset 800 is adjustable. In particular, the counterweight element 807 can be foldable and/or removable.

In an advantageous manner, loudspeakers (not shown) can also be arranged in the mixed-reality headset 800, which simulate the sounds expected in a real manual welding process. It is known that acoustics are an essential element in welding. For example, during arc welding, sounds can be associated with the properties of the arc, such as the power transported by the arc or the so-called angle of attack of the welding torch, which can determine the angle between the arc and the workpiece. To generate the sounds, an acoustic model can be provided in the simulation unit 9 in addition to the simulation model 91 for simulating the welding process. The loudspeakers can be arranged in such a way that they are able to provide spatial stereo sound, which can often offer the manual welder 2 a particularly realistic representation (“immersion”) of the virtual manual welding process.

FIG. 5 is a front view of a mixed-reality headset 800 and an adapter 30 for fixing an IR camera 804 in a predetermined relative position to an RGB camera 803. With regard to the position of the RGB camera 803 and of the IR camera 804 on the mixed-reality headset 800, it was determined that these should preferably be mounted in as rigid an arrangement as possible to one another.

As can be seen in particular from FIG. 4 and FIG. 5, the RGB camera 803 and the IR camera 804 are vertically offset from one another. This vertical offset must be taken into account when superimposing the virtual weld seam, which is determined from IR images, on the RGB images obtained using the RGB camera. It has been shown here that temporal changes in this vertical offset can be taken into account, but this requires the determination of the vertical offset and the use of significantly higher computing capacities.

In FIG. 4 and FIG. 5, both the RGB camera 803 and the IR camera 804 each comprise two optical lenses. The use of two optical lenses in the RGB camera 803 makes possible the capture of so-called stereoscopic photos or images of the RGB field of vision 809. It is known that stereoscopic images are understood as the reproduction of images with an impression of spatial depth. Stereoscopic images can be used here to provide the manual welder 2 with a stereoscopic representation of the virtual manual welding process. In an advantageous embodiment, two stereoscopically offset mixed-reality images 12 can always be displayed simultaneously in real time on the mixed-reality display 801 of the mixed-reality headset 800.

Furthermore, further sensors can also be provided on the RGB camera 803 and/or on the mixed-reality headset 800 in order to be able to detect the orientation of the training workpiece 4, of the training manual welding torch 6, of the mixed-reality target object T in the 3D welding environment 3 or generally in three-dimensional space, as already mentioned earlier. These sensors can be, for example, gyroscopes, acceleration sensors and/or proximity sensors. The sensor data recorded by such sensors can be advantageously forwarded to the simulation unit 9, in which said orientation in three-dimensional space can be determined from the transmitted sensor data.

The adapter 30 thus serves to advantageously ensure a vertical offset between the RGB camera 803 and the IR camera 804 that is always (as) constant (as possible).

The embodiment of the adapter 30 shown in FIG. 5 has a rigid mounting frame 33 on which two mounting elements 31, 32 are arranged in a defined spatial position. The RGB camera 803 is fastened using the first mounting element 31, and the IR camera 804 is fastened by means of the second mounting element 32.

FIG. 6 further shows fields of vision 809, 810 of an RGB camera 803 and of an IR camera 804, as can result in a welding training assembly 1 according to the invention. It can be seen that the IR field of vision 810 is designed to be much larger than the RGB field of vision 809. In order to be able to ensure that objects captured by the RGB camera 803, such as a training workpiece 4 or a training manual welding torch 6, can be taken into account when determining the virtual weld seam 13, which according to the invention is based on IR images captured by means of the IR camera 804, it is necessary that the fields of vision 809, 810 of the camera, i.e. the RGB field of vision 809 and the IR field of vision 810, overlap, at least in part. “Overlapping” is to be understood here as the RGB field of vision and the IR field of vision at least partially overlapping one another.

In a particularly advantageous embodiment of the invention, it can be provided that the IR field of vision 810 completely encloses the RGB field of vision 809, i.e. that the RGB field of vision 809 is completely contained within the IR field of vision 810. However, this is not a mandatory requirement within the scope of the invention.

From FIG. 6, a substantial advantage of the use according to the invention of two camera systems can be seen. In the case shown, the reference pattern 72 intended for individualizing the training workpiece 4 is located outside the RGB field of vision 809 of the RGB camera 803. In this case, identification and tracking, i.e. tracking of the training workpiece 4, would not be possible on the basis of RGB images alone. On account of the larger IR field of vision, the reference pattern 72 can, however, still be captured and, even in this case, a virtual manual welding process can be carried out without any problems.

The IR-reflecting reference markers essential for the present invention will be discussed in more detail by means of FIG. 7. For this purpose, FIG. 7 shows various designs of a training manual welding torch 6 but also of additional training training materials 7, which can be used to simulate shielded metal arc welding processes and TIG welding processes. However, the following statements are equally valid for reference patterns 72 for training workpieces 4.

According to the invention, the individualizing reference patterns 72, 74 are designed such that even the detection of only part of the relevant reference pattern 72, 74 is sufficient to identify the object to which a corresponding reference pattern 72, 74 has been applied.

Depending on the type and design of a training manual welding torch 6, it may be necessary in the simulation in the simulation unit 9 to take into account different types of welding electrodes in the form of virtual welding electrodes. Preferably, the type of virtual welding electrode can be identified together with the type of training manual welding torch 6. However, it is also conceivable to provide a welding electrode as part of a training manual welding torch 6 and to also provide this welding electrode with IR-reflecting reference markers 73 such that a welding electrode can also be directly identified and subsequently taken into account in the simulation as a virtual welding electrode.

With regard to the training manual welding torches 6 considered in this case, various checks can also be provided, which are preferably carried out in the simulation unit 9. For example, connections of a training manual welding torch 6, such as a ground connection and/or a torch connection, can be checked, or a check be made to see whether the correct training manual welding torch 6 is being used, which is particularly relevant in the context of MIG/MAG welding. Furthermore, a check can be made to see whether a training manual welding torch 6 is connected to the correct electrical polarity, or whether a ground connection is correctly connected to a training workpiece 4, or whether a ground connection is correctly connected in general and/or whether a welding circuit is closed. The aforementioned checks or the results of these checks can be graphically displayed on the mixed-reality display 801, whereby in particular faulty or missing connections can be pointed out and, in the case of a faulty or missing connection, instructions for suitably correcting this can also be provided.

For this purpose, in the first reference pattern 72 for individualizing the training workpiece 4, a first distance can be provided between the IR-reflecting reference markers 71, by which each IR-reflecting reference marker 71 is spaced apart from the adjacent IR-reflecting reference markers 71, and, in the second reference pattern 72 for individualizing the training workpiece 4, a second distance can be provided which is different from the first distance.

Other properties of patterns can also be used to distinguish the reference patterns 72, 74 used, such as different grid structures. The IR-reflecting reference markers 71, 73 can also form mutually different fractals. Mutually different fractals can be generated, for example, on the basis of different Mandelbrot sets. However, reference patterns can also be generated using random generators or determined empirically when designing the welding training assembly 1.

An important advantage of the use according to the invention of IR-reflecting reference markers is that, compared with the prior art, much smaller reference markers can be used. Specifically, the diameters of the IR-reflecting reference markers 71, 73 can be selected to be within a range between 0.1 mm and 5 mm or in a range between 0.1 mm and 3 mm or in a range between 0.1 mm and 1 mm.

The diameters of the IR-reflecting reference markers 71, 73 can also be used to distinguish between different reference patterns 72, 74. IR-reflecting reference markers 71 with a first diameter, for example of 0.5 mm or 1.5 mm or 2.5 mm or 3.5 mm, can thus be used in the first reference pattern 72, and IR-reflecting reference markers 74 with a second diameter, for example of 0.1 mm or 1.1 mm or 2.1 mm or 3.1 mm, can be used in the second reference pattern 74.

In order to be able to reliably guarantee detection of the objects individualized by the IR-reflecting reference markers, it must be ensured that the parts of the surfaces of the objects not covered by IR-reflecting reference markers 71, 73 are less IR-reflective than the markers themselves, i.e. that the parts of the surface of the training workpiece 4 arranged between the IR-reflecting reference markers 71, 73 and the parts of the surface of the training manual welding torch 6 arranged between the IR-reflecting reference markers 71, 73 and the parts of the surface of the mixed-reality target object T arranged between the IR-reflecting reference markers 71, 73 are less IR-reflective than the IR-reflecting reference markers 71, 73, 75.

In a further embodiment, the reflection properties of the reference markers and of the surfaces of the training workpiece 4 and of the training manual welding torch 6 can also be designed inversely with respect to the embodiments described thus far. Accordingly, the surfaces of the training workpiece 4 and of the training manual welding torch 6 can be designed to be more reflective than the reference markers. In this way, reference patterns detectable by the IR camera can also be made on the training workpiece 4 and the training manual welding torch 6.

It is to be noted that the training manual welding torch 6 can be designed as a real manual welding torch, for example as a real MIG manual welding torch or as a real MAG manual welding torch or real TIG manual welding torch or real shielded metal arc welding torch. Within the scope of the present invention, it is therefore possible to take a real manual welding torch from a real welding arrangement for real welding, to equip it with IR-reflecting reference markers 73 having a reference pattern 74 that individualizes the manual welding torch, and thus to use the real manual welding torch as a training manual welding torch 6 when carrying out the virtual manual welding process.

In a preferred embodiment of a training manual welding torch 6, operating elements S1, S2, such as switches, buttons, slide controls, etc., can be provided on the training manual welding torch 6 as on a real manual welding torch. In real manual welding torches, such operating elements S1, S2 are used to control a welding process, for example to start it, e.g. to ignite an arc, or to vary a welding current, or to change a wire feeding speed. Preferably, a training manual welding torch 6 can have the same operating elements S1, S2 and can pass control signals generated by these operating elements S1, S2 on to the simulation unit 9, for example by means of a cable connection. In the simulation unit 9, the effect of these control signals can subsequently be taken into account in the simulation of the manual welding process, i.e. the simulated welding process can be started or interrupted, a simulated wire feed can be accelerated or braked, or a simulated welding current can be increased or reduced.

In this context, it was found that due to the design of the reference markers 71, 73 according to the invention, error-free execution of virtual manual welding processes is even possible when the RGB camera 803 is so close to the training workpiece 4 that the RGB camera 803 and the training workpiece 4 touch.

FIG. 8 shows a plurality of possible design options of a first reference pattern 72 for individualizing various training workpieces 4. It can be seen that the IR reference markers 71 can also be applied to the end faces and lateral surfaces of the training workpieces 4 due to their small size. The statements made in respect of FIG. 7 regarding the design of the IR-reflecting reference markers 71 also apply without restriction to the IR-reflecting reference markers 71 on training workpieces 4, as in FIG. 8.

The IR-reflecting reference markers 71, 73 can, for example, be applied to the surface of the training workpiece 4 in the form of an adhesive film or can also be painted, printed or embossed on the surface of the training workpiece 4 or even applied by a coating process. Furthermore, it would also be possible to provide such IR-reflecting reference markers 71, 73 on a surface of a training workpiece 4 by introducing energy onto the surface, for example in the form of an engraving laser.

FIG. 9 shows a further possible design of a first reference pattern 72 for individualizing a training workpiece 4. What is particularly noteworthy about the reference pattern 72 shown in FIG. 9 are two depressions 16 formed in the upper part of the training workpiece 4. The depressions 16 represent recesses, i.e. dips in the surface of the training workpiece 4. IR-reflecting reference markers 71 are arranged in these recesses, but due to the recess they can only be detected by the IR camera 804 from certain viewing angles.

FIG. 10 is a detailed view of a depression 16 for arranging an IR-reflecting reference marker 71.

Due to the fact that IR-reflecting reference markers 71 arranged in a depression 16 can only be detected by the IR camera 804 from certain viewing angles, their detection can be used to draw conclusions about the spatial orientation of the training workpiece 4, for example. In the situation shown in

FIG. 9, both IR-reflecting reference markers 71 arranged in the depressions 16 are thus visible, implying that the training workpiece 4 is oriented with one long side of the training workpiece 4 facing the IR camera 804. However, if only one IR-reflecting reference marker 71 arranged in a depression 16 is visible, it can be assumed that the training workpiece 4 is oriented such that a transverse side faces the IR camera 804.

FIGS. 11a to 11c further show the activation of a menu M on the mixed-reality display of the mixed-reality headset 800 when a mixed-reality target object T is detected by the IR camera 804. In order to enable the activation of the menu M, a third plurality of IR-reflecting reference markers 75 are arranged on the mixed-reality target object T in a third reference pattern 76 that individualizes the mixed-reality target object T. If at least part of the third reference pattern 76 is captured by the IR camera 804, the display of the menu M on the mixed-reality display 801 will be initiated. The mixed-reality target object T can be arranged in the desired position in the 3D welding environment 3 for this purpose.

In a preferred embodiment of the invention, the orientation of the menu M can depend on the spatial orientation of the mixed-reality target object T such that the spatial orientation of the menu M changes when the spatial orientation of the mixed-reality target object T changes.

In a further preferred embodiment of the invention, a further reference pattern 77 can also be arranged on a training workpiece 4, which can also display a menu M. As in the case of the mixed-reality target object T, the orientation of the displayed menu M can in this case be made to be dependent on the spatial orientation of the training workpiece 4.

A number of functions can be implemented using the menu M displayed. The menu M can thus be designed to modify the at least one training welding parameter p_{S}, which ultimately allows the entire virtual manual welding process to be modified and changed.

The above-described display of a menu M can, however, also take place on a further display element 14, which is detachably connected to the simulation unit 9, for example in the form of a tablet. In this way, other persons besides the manual welder 2 can also follow the menu and, if necessary, also operate it.

In an advantageous embodiment of the invention, it can be provided to synchronize a smartphone with the welding training assembly 1 and to use the display of the smartphone to display the menu.

In a further advantageous embodiment of the invention, the training manual welding torch 6 can be equipped with a further operating element which allows the displayed menu M to be operated.

For this purpose, the orientation of the training manual welding torch 6 can first be determined in the manner already described. On the basis thereof, a menu item identified by the orientation of the training manual welding torch 6 can be ascertained in the menu M, for example by determining a menu item which is intersected by a straight line emanating from the training manual welding torch 6 and which was ascertained when being identified. Once a menu item has been identified, it can be activated and/or deactivated by actuating the other operating element.

The actuation/confirmation of menu items of the menu M can be carried out on the one hand by pointing at a virtual straight line of the menu proceeding from a menu item, wherein the virtual straight line can also be displayed, and by subsequently pressing a button of an operating element S1, S2, as shown in FIGS. 11a and 11b. Furthermore, the “dwell-based pointing” method (“pointing and loading”) established in the field of human-computer interaction can also be used to select a menu item, and a menu item can also happen by virtually touching it with the training manual welding torch 6.

Further, FIG. 12a and FIG. 12b show a so-called welding root 15 as the subject of a further advantageous embodiment of the invention. In FIG. 12a, the lower side I of a training workpiece 4 is shown, and in FIG. 12b the opposite upper side II is shown. On the upper side II shown in FIG. 12b, a virtual weld seam 13 can be seen, which creates a so-called weld root 15 on the lower side I.

Specifically, the simulation unit 9 can be advantageously designed to first determine a virtual weld root 15 or virtual penetration welding or a virtual longitudinal crack or a virtual transverse crack through the weld seam 13 generated on the training workpiece 4 by the virtual manual welding process. On the basis of such an ascertainment, the simulation unit 9 can advantageously be designed to superimpose the determined virtual weld root 15 or the determined virtual penetration welding or the determined virtual longitudinal crack or the determined virtual transverse crack on the RGB image provided at the current pint in time T_{cur}.

The display of a weld root 15 or a transverse crack or a longitudinal crack is of particular interest in cases where the training workpiece 4 is analyzed during the virtual manual welding process, for example by interrupting the welding process and viewing the training workpiece 4 from all sides, for example from the lower side, or by rotating the training workpiece 4. The possibility of observing a weld root 15 in such cases or of checking whether the workpiece has been penetrated sometimes makes the virtual welding process significantly more realistic.

1. A welding training assembly for performing a virtual manual welding process, comprising
a training workpiece;
a movable training manual welding torch;
a first plurality of IR-reflecting reference markers which are arranged in a first reference pattern on the training workpiece, the first reference pattern individualizing the training workpiece;
a second plurality of IR-reflecting reference markers which are arranged in a second reference pattern on the training manual welding torch, the second reference pattern individualizing the training manual welding torch;
a mixed-reality headset, comprising:
a predetermined geometric headset reference point;
a mixed-reality display for displaying a sequence of mixed-reality images of the virtual manual welding process;
an RGB camera with a spatial RGB field of vision for capturing RGB images of objects located in the RGB field of vision, wherein at least part of the training workpiece and at least part of the training manual welding torch are located in the RGB field of vision when the virtual manual welding process is performed, and wherein the mixed-reality display and the RGB camera are arranged along a line of sight of the mixed-reality headset; and
an IR camera which is arranged in a predetermined position relative to the RGB camera, the IR camera having a spatial IR field of vision for capturing IR images of IR-reflecting reference markers located in the IR field of vision, wherein the IR field of vision is larger than the RGB field of vision and wherein the IR field of vision and the RGB field of vision at least partially overlap, wherein at least part of the first reference pattern and at least part of the second reference pattern are located in the IR field of vision when the virtual manual welding process is performed;
a simulation unit which is designed to:
determine a geometry and/or shape and/or type of the training manual welding torch and of the training workpiece and to, from the parts of the first and second reference patterns captured in the IR images, determine a progression over time of the spatial positions of the training manual welding torch and of the training workpiece relative to the headset reference point;
by taking into account at least one predetermined training welding parameter and by taking into account a progression over time of a position of a virtual welding electrode of the training manual welding torch determined from the progression over time of the spatial position of the training manual welding torch determine a virtual weld seam on the training workpiece;
superimpose on the RGB image provided at a current point in time of the virtual manual welding process at least that part of the virtual weld seam determined up to the current point in time that is within the RGB field of vision provided at the current point in time, to create a mixed-reality image of the virtual manual welding process at the current point in time;
transmit the determined mixed-reality image to the mixed-reality display in order to display it as part of the sequence of mixed-reality images of the virtual manual welding process on the mixed-reality display, wherein a mixed-reality target object is provided, on which a third plurality of IR-reflecting reference markers are arranged in a third reference pattern individualizing the mixed-reality target object, wherein the mixed-reality display is designed to display a menu for changing the at least one training welding parameter on the mixed-reality display when at least a part of the third reference pattern is recorded by the IR camera, and wherein the at least one training welding parameter can be modified by operating the menu displayed on the mixed-reality display.

2. (canceled).

3. The welding training assembly according to claim 1, wherein the diameters of the IR-reflecting reference markers are in a range between 0.1 mm and 5 mm or in a range between 0.1 mm and 3 mm or in a range between 0.1 mm and 1 mm.

4. The welding training assembly according to claim 1, wherein the parts of the surface of the training workpiece between the IR-reflecting reference markers and the parts of the surface of the training manual welding torch between the IR-reflecting reference markers and the parts of the surface of the mixed-reality target object between the IR-reflecting reference markers are less IR-reflective than the IR-reflecting reference markers, or vice versa.

5. The welding training assembly according to claim 1, wherein the mixed-reality headset has a counterweight element which counteracts a torque forming as a result of the weight of the RGB camera and/or of the weight of the IR camera and/or of the weight of the mixed-reality display and acting normally with respect to the line of sight of the mixed-reality headset.

6. The welding training assembly according to claim 5, wherein the geometric shape of the counterweight element is changeable and/or its position on the mixed-reality headset is adjustable.

7. The welding training assembly according to claim 1, wherein the at least one predetermined training welding parameter corresponds to a workpiece geometry or a welding current or a welding voltage or a welding speed or an idle time or a preheating temperature or a wire feed speed or an arc length or a welding type.

8. The welding training assembly according to claim 1, wherein the simulation unit has a display element, preferably detachable from the simulation unit, for displaying the sequence of mixed-reality images of the virtual manual welding process.

9. The welding training assembly according to claim 1, wherein a workpiece holder is provided on which the training workpiece can be mounted.

10. The welding training assembly according to claim 9, wherein the training workpiece can be magnetically mounted on the workpiece holder.

11. The welding training assembly according to claim 1, wherein the simulation unit is arranged on the mixed-reality headset.

12. The welding training assembly according to claim 1, wherein the simulation unit is designed to use the determined virtual weld seam as a basis for determining a virtual metallurgical structure and/or a virtual stress-induced distortion and/or a virtual grain structure of the metallurgical structure in a subsequent mechanical simulation, which can form as a result of the virtual weld seam in the training workpiece.

13. The welding training assembly according to claim 12, wherein the simulation unit is designed to use one of the variables determined in the subsequent mechanical simulation to determine a welding quality parameter which describes the quality and/or grade of the virtual weld seam.

14. The welding training assembly according to claim 1, wherein the simulation unit is designed to superimpose a predetermined virtual ideal weld seam to be generated by the virtual manual welding process on the provided RGB images, and wherein the mixed-reality display is designed to display the RGB images superimposed with the virtual ideal weld seam.

15. The welding training assembly according to claim 14, wherein the simulation unit is designed to determine a seam quality parameter which describes a difference between the virtual weld seam determined and the predetermined ideal weld seam.

16. The welding training assembly according to claim 1, wherein the simulation unit is designed to determine a virtual weld root or a virtual penetration welding or a virtual longitudinal crack or a virtual transverse crack generated by the virtual manual welding process on the training workpiece, and wherein the simulation unit is designed to superimpose the determined virtual weld root or the determined virtual penetration welding or the determined virtual longitudinal crack or the determined virtual transverse crack on the RGB image provided at the current point in time.

17. The welding training assembly according to claim 1, wherein the training workpiece has at least one depression or at least one recess and wherein a reference marker of the first reference pattern is arranged in said at least one depression or in said at least one recess.

18. The welding training assembly according to claim 1, wherein the training manual welding torch corresponds to a real TIG manual welding torch or a real MIG manual welding torch or a real MAG manual welding torch or a real shielded metal arc welding torch.

19. The welding training assembly according to claim 1, wherein further sensors are provided on the mixed-reality headset, preferably a gyroscope and/or an acceleration sensor and/or a proximity sensor, which record sensor data for determining the spatial orientation of the training workpiece and/or the training manual welding torch and/or the mixed-reality target object in three-dimensional space, wherein the sensor data recorded by the other sensors are transmitted to the simulation unit and wherein the simulation unit determines from the transmitted sensor data the spatial orientation of the training workpiece and/or of the training manual welding torch and/or of the mixed-reality target object in three-dimensional space.

20. A method for performing a virtual manual welding process using a welding training assembly according to claim 1, wherein
a manual welder wears the mixed-reality headset of the welding training assembly;
the manual welder manually moves the training manual welding torch of the welding training assembly to produce a virtual weld seam on the training workpiece of the welding training assembly;
RGB images of the parts of the training manual welding torch and the training workpiece located in the RGB field of vision of the RGB camera are captured by the RGB camera of the welding training assembly;
IR images of IR-reflecting reference markers located in the IR field of vision of the IR camera are captured by the IR camera of the welding training assembly;
in the simulation unit of the welding training assembly:
a geometry and/or a shape and/or a type of the training manual welding torch and of the training workpiece is/are determined from the captured IR images;
the progression over time of the spatial positions of the training manual welding torch and of the training workpiece relative to the headset reference point of the mixed-reality headset of the welding training assembly are determined from the parts of the first and the second reference patterns captured with the IR images;
a virtual weld seam on the training workpiece is determined from the progression over time of the spatial position of the training manual welding torch taking into account at least one predetermined training welding parameter and a progression over time of a position of a virtual welding electrode;
at least that part of the virtual weld seam that is determined up to a current point in time of the virtual manual welding process and that is within the RGB field of vision provided at the current point in time superimposed on the RGB image provided at the current point in time in order to create a mixed-reality image of the virtual manual welding process at the current point in time; and
the determined mixed-reality image is displayed as part of a sequence of mixed-reality images of the virtual manual welding process on the mixed-reality display of the mixed-reality headset of the welding training assembly, wherein a mixed-reality target object is provided, on which a third plurality of IR-reflecting reference markers are arranged in a third reference pattern individualizing the mixed-reality target object, wherein a menu for changing the at least one training welding parameter is displayed on the mixed-reality display when at least a part of the third reference pattern is recorded by the IR camera, and wherein the at least one training welding parameter is modified by operating the menu displayed on the mixed-reality display.
